(19) United States
(12) Patent Application Publication
(10) Pub. No.: US 2006/0062502 A1
(43) Pub. Date: Mar. 23, 2006

(54) Solid lubrication of rod end bearings

(75) Inventor: Evan Hupp, Ely, IA (US)

Correspondence Address: INTERNATIONAL PAPER COMPANY, 6285 TRI-RIDGE BOULEVARD, LOVELAND, OH, 45140, US

(73) Assignee: International Paper Company, Stamford, CT (US)

(21) Appl. No.: 10/947,508

(22) Filed: Sep. 22, 2004

(51) Int. Cl. F16C 25/04; F16C 23/08; F16C 23/04; F16C 33/74

(52) U.S. Cl. 384/213

(57) ABSTRACT

A self-lubricating bearing includes an outer bearing member having a bore configured to receive an inner bearing member and an inner bearing member disposed within the bore with the inner bearing member capable of rotating relative to the outer bearing member. At least one of the outer and inner bearing members includes a lubricating material that defines a discrete lubricating region of an associated bearing surface. The lubricating material fills a preform cavity extending inwardly from the surface of the respective bearing member.

### TECHNICAL FIELD

The present application relates to self-lubricating bearings and methods of forming self-lubricating bearings.

### BACKGROUND

Self-lubricating bearings are particularly useful in systems where, for example, access to the bearings for manual lubrication is difficult. Self-lubricating roller type bearings have been proposed that include a film of a lubricant material that is deposited on all friction surfaces of the bearing. The lubricant reduces the friction between the inner race and the outer race of the roller type bearing during operation. The lubricant is deposited by filling a gap between the inner and outer race of the bearing with the lubricant material and bonding the lubricant material to the friction surfaces of the bearing.

### SUMMARY

In aspects, a self-lubricating bearing includes a discrete lubricating region of an associated bearing surface and one or more of the following features.

In an aspect, the invention features a self-lubricating bearing including an outer bearing member having a bore configured to receive an inner bearing member and an inner bearing member disposed within the bore with the inner bearing member capable of rotating relative to the outer bearing member. At least one of the outer and inner bearing members includes a lubricating material that defines a discrete lubricating region of an associated bearing surface. The lubricating material fills a preform cavity extending inwardly from the surface of the respective bearing member.

In another aspect, the invention features a method of making a self-lubricating bearing including an outer bearing member having a bore configured to receive an inner bearing member and an inner bearing member disposed within the bore such that the inner bearing member is capable of rotating relative to the outer bearing member. The method includes forming a cavity extending inwardly from a bearing surface of at least one of the inner and outer bearing members and filling the cavity with a lubricating material to define a discrete lubricating region of the respective bearing surface.

In another aspect, the invention features a method of making a self-lubricating bearing comprising an outer bearing member having a bore configured to receive an inner bearing member and an inner bearing member disposed within the bore such that the inner bearing member is capable of rotating relative to the outer bearing member. The method includes forming a discrete lubricating region of an associated bearing surface of at least one of the inner and outer bearing members by filling a preform cavity extending inwardly from the surface of the respective bearing member with a lubricating material. The lubricating material has a kinetic coefficient of friction less than a kinetic coefficient of friction of a bearing material forming the associated bearing surface at a region adjacent the lubricating region.

In some embodiments, the inner bearing member and outer bearing member are configured such that the inner bearing member has three degrees of freedom relative to the outer member. In some cases, only the inner bearing member comprises the lubricating material. In other cases, only the outer bearing member comprises the lubricating material.

In some embodiments the preform cavity is formed by machining or casting The lubricating material may include graphite. In some cases, the lubricating material has a kinetic coefficient of friction less than a kinetic coefficient of friction of a bearing material forming the associated bearing surface at a region adjacent the lubricating region.

In certain embodiments, the self-lubricating bearing is in the form of a rod end bearing or a spherical plain bearing.

In some cases, methods may include curing the lubricating material to permanently bond the lubricating material to the respective bearing member within the associated cavity.

Aspects may include one or more of the following advantages. Lubricating material can be applied to a plain bearing having a cartridge-type inner member. The bearings can provide a maintenance free method of lubricating the bearing for the life of the bearing, which can allow the bearings to be placed in remote positions, e.g., that do not allow for external lubrication methods. The preform cavities can be formed to only minimally affect the strength of the bearing. In certain embodiments, there is relatively little or no lubrication leak out of the bearing during operation. The lubricant material can be selected for use in a wet environment, suitable for use in chemicals such as common solvents, acids and alkalis and/or for use within a wide range of temperatures (e.g., between about −250 and about 660 degrees F.). The lubricating material can also be selected to provide relatively contaminate free working conditions by minimizing contaminate attraction into the bearing which can cause failure.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of an embodiment of a rod end bearing including a bearing portion and a rod portion;

FIG. 1A is a section view of the rod portion along line A-A of FIG. 1;

FIG. 2 is an exploded view of the rod end bearing of FIG. 1;

FIG. 2A is a section view along line A-A of FIG. 2;

FIG. 3 is a perspective view of an alternative inner bearing member embodiment;

FIG. 4 is a perspective view of an alternative inner bearing member embodiment;

FIG. 5 is a perspective view of an outer member embodiment of a rod end bearing;

FIG. 6 is a perspective view of another embodiment of an outer member of a rod end bearing;

FIG. 7 is a perspective view of another embodiment of an outer member of a rod end bearing;

FIG. 8 is an exploded view of an embodiment of a spherical plain bearing;

FIG. 9 is a section view of an embodiment of a bearing having an inner member and an outer member;

FIG. 10 is a section view of another embodiment of a bearing having an inner member and an outer member; and

FIG. 11 is a section view of another embodiment of a bearing having an inner member and an outer member.

### DETAILED DESCRIPTION

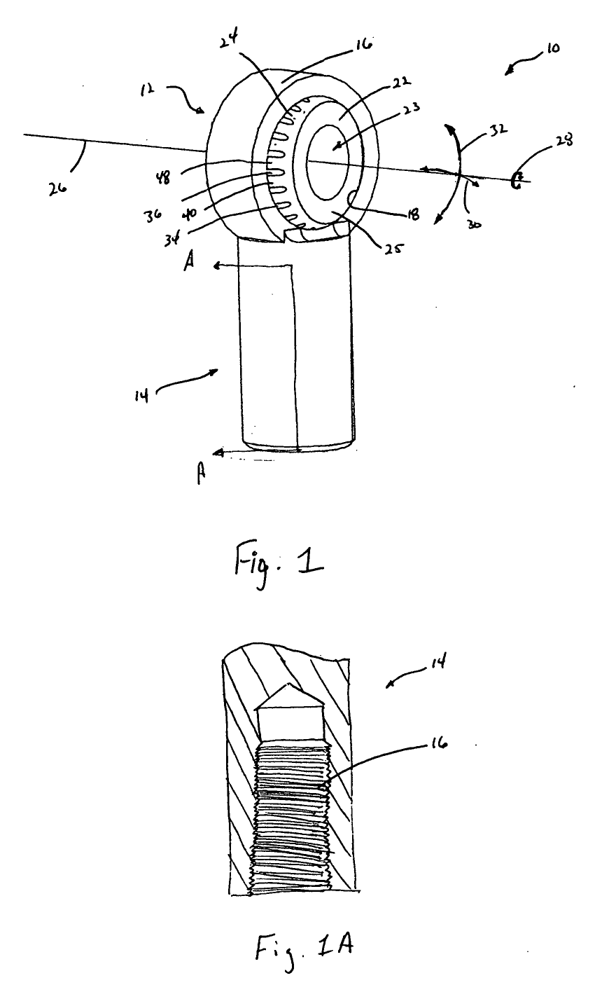

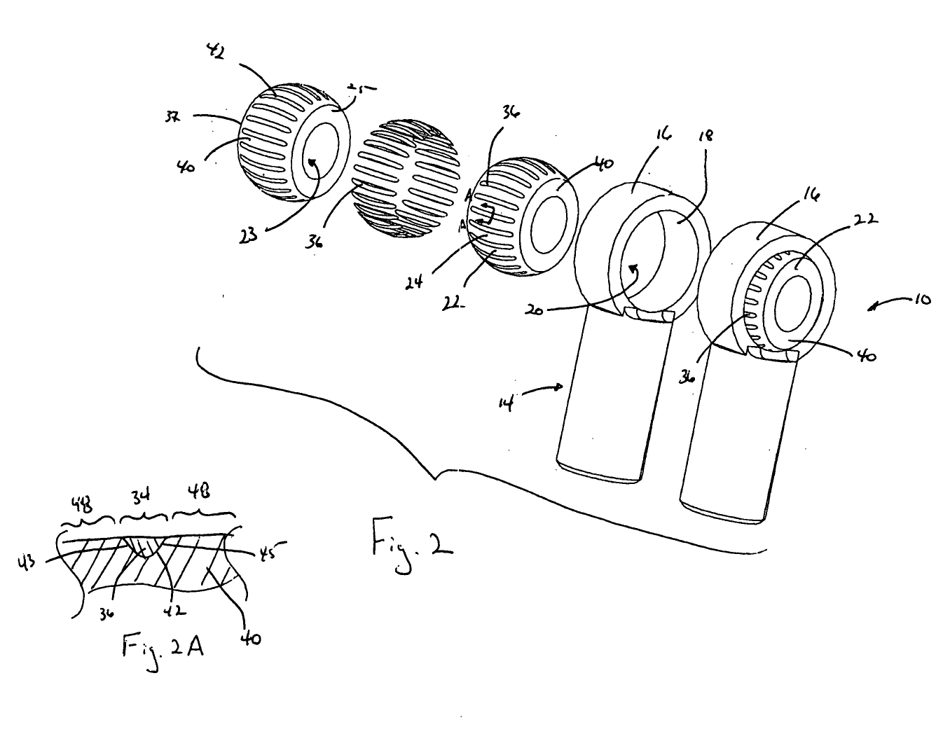

Referring to FIG. 1, a rod end bearing 10 includes a bearing portion 12 and a rod portion 14 having female threads 16 (FIG. 1A) for receiving a mating, male threaded member (not shown) such as a threaded rod or shaft. In some embodiments, the rod portion includes male threads for receiving a mating female threaded member (not shown). The bearing portion 12 includes an outer bearing member 16 having a concave inner surface 18 (see FIG. 2) that forms a bore 20 extending through the outer bearing member. Disposed within the bore 20 of the outer bearing member 16 is a ring-shaped inner bearing member 22 having a correspondingly convex outer surface 24 and an opening 23 extending between its front and rear surfaces 25, 37 (FIG. 2), e.g., sized to receive a shaft. The inner bearing member 22 is movable relative to the outer bearing member 16 within bore 20 along the respective outer and inner surfaces 24, 18 in a bearing relationship. As will be described in greater detail below, at least one of the outer and inner bearing members 16, 22 includes a solid lubricating material 36 bonded to the associated bearing member to form a discrete lubricating region 34 of the associated bearing member surface.

Referring still to FIG. 1, due to the corresponding surfaces 18 and 24 of the outer and inner bearing members, respectively, inner bearing member 22 has more than one degree of freedom relative to outer bearing member 16. As shown, inner bearing member 22 has three degrees of freedom relative to the outer member 16. Particularly, inner bearing member 22 can rotate about axis 26 in the direction of arrow 28 and can also roll in the directions of arrows 30 and 32. This rolling capability of rod end bearing 10 reduces the influence of angular misalignment during operation (e.g., when compared to the influence of angular misalignment on bearings having only one degree of freedom such as cylindrical bearings).

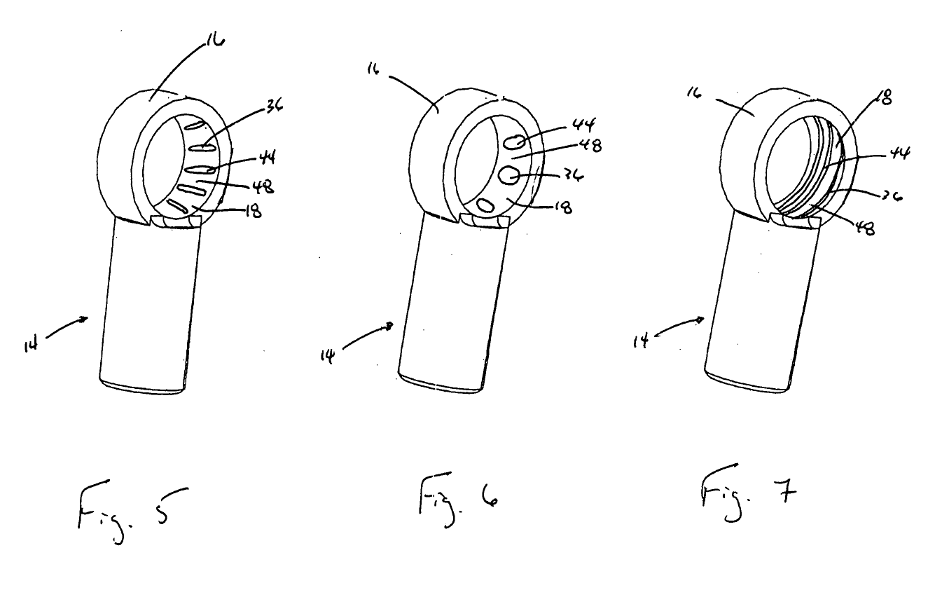

During use, as the inner bearing member 22 is moved within the bore 20 of the outer bearing member 16, sliding contact occurs between surfaces 18 and 24. To reduce friction between the surfaces 18 and 24 (e.g., due to the bearing material combination, working load and velocity), surface 24 of the inner bearing member 22 includes discrete regions 34 of lubricating material 36 that provide lubrication between the surfaces 18 and 24. In some embodiments, only inner bearing member 22 includes lubricating material 36. In other embodiments, outer bearing member 16 includes discrete regions lubricating material (see FIGS. 5-7). The lubricating material 36 is bonded within cavities 42 (e.g., grooves, holes, etc.; see FIG. 2 for example) extending from surface 24 and toward opening 23.

Due to the addition of the lubricating material 36, the outer surface 24 of the inner bearing member 22 at regions 34 is formed of a material having a kinetic coefficient of friction that is less than that of bearing material 40 forming surface 24 at adjacent regions 48 (FIG. 2A). As will be apparent to those of ordinary skill in the art, it is appreciated that comparative references of the coefficients of friction of the bearing material and lubricating material are relative to the same scale, criteria, and/or standard. For example, in some embodiments, inner surface 18 of outer bearing member 16 and outer surface 24 of inner bearing member 22 at region 48 are formed of steel. In this embodiment, the kinetic coefficient of friction of the outer surface 24 at region 34 may be less than 0.6 (i.e., the kinetic coefficient of friction measured for steel (dry) on steel (dry), e.g., according to a pre-selected standard). In some embodiments, the kinetic coefficient of friction of surface 24 at region 34 is between about 0.03 and 0.5.

Any suitable bearing material may be used to form surface 24 at region 48, such as steel or steel alloys including stainless steel, iron, copper or copper alloys including bronze and impregnated bronze (e.g., Teflon® impregnated bronze), graphite, etc. Any suitable lubricating material having a kinetic coefficient of friction that is less than that of the bearing material forming surface 24 in region 48 and capable of filling and permanently bonding to inner member 16 within cavity 42 may be used, such as a material including graphite.

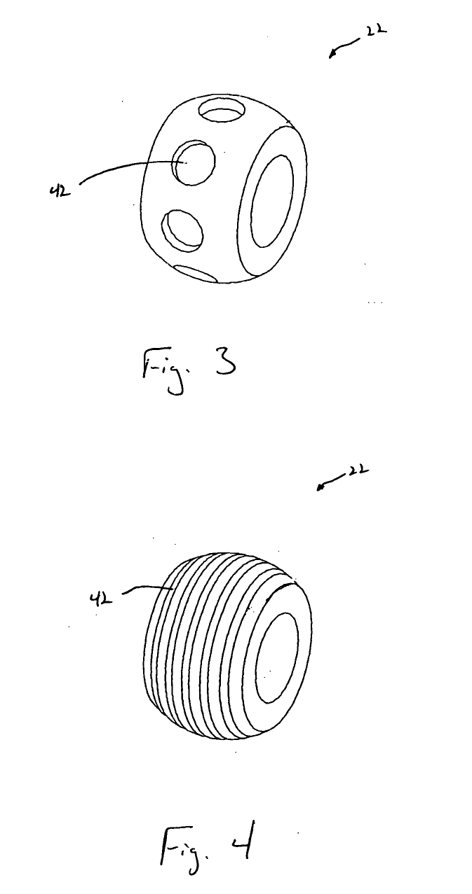

In some embodiments, the lubricating material 36 at regions 34 has a static coefficient of friction that is less than the static coefficient of friction of bearing material forming adjacent regions 48. Suitable methods of measuring kinetic and static coefficients of friction can be selected according to ASTM G115-04 “Standard Guide for Measuring and Reporting Friction Coefficients.”Referring now to FIG. 2, each cavity 42 is in the form of an axially extending, elongated groove. The grooves 42 are aligned in an array with each groove being spaced apart about the inner member's periphery and parallel to adjacent grooves. Any other suitable pattern can be formed. For example, referring to FIGS. 3 and 4, cavities 42 can be in the form of spaced apart round cavities or holes (FIG. 3), or cavities 42 can be in the form of continuous, parallel grooves that are axially spaced apart from each other. Other configurations are contemplated, such as cavities including corners, crisscrossed grooves, serpentine grooves, zigzagged grooves, combinations of patterns, etc. Suitable methods of forming the cavities 42 include casting and/or machining.

Referring to FIG. 2A, lubricating material 36 is bonded to the bearing material 40 within the cavities 42. As shown, cavity 42 has a U-shaped cross-section, however, other configurations such as V-shaped, rounded or angled side surfaces 43 and 45 are possible. In some embodiments, surfaces 43 and 45 are finished to provide suitable bonding surfaces.

In some cases, the lubricating material is a mixture of a lubricant, such as graphite, and a carrier material that can be applied to the inner bearing member 16 within cavities 42, e.g., in the form of a paste. The mixture can be hardened and bonded (e.g., using a pressure and heat curing process) to the bearing material within cavities 42 to form the discrete lubricating region 34 of surface 24. As can be seen, the lubricating material 36 fills the cavity 42 forming region 34 that is flush with adjacent region 48. In some cases, it may be necessary to finish inner bearing member 16 (e.g., to remove some of lubricating material 36 and/or bearing material 40) to form a flush surface once the lubricating material 36 is bonded within the cavities 42. A suitable lubricant mixture capable of filling and permanently bonding within cavity 42 and associated bonding/hardening process are available from Cobra Solid Lubricants of Unique Technology Associates (UTA), Staten Island, N.Y.

Referring now to FIGS. 5-7, as indicated above, the outer bearing member 16 can include lubricating material 36 to form a discrete lubricating region 44 of the inner surface 18. In some embodiments, only the outer bearing member 16 includes the lubricating material 36. As above, the lubricating material 36 is bonded within cavities 42 to form discrete lubricating regions 34 where, within the lubricating regions, the inner surface 18 is formed of lubricating material having a coefficient of friction that is less than a bearing material 40 forming an adjacent region 48 of the inner surface.

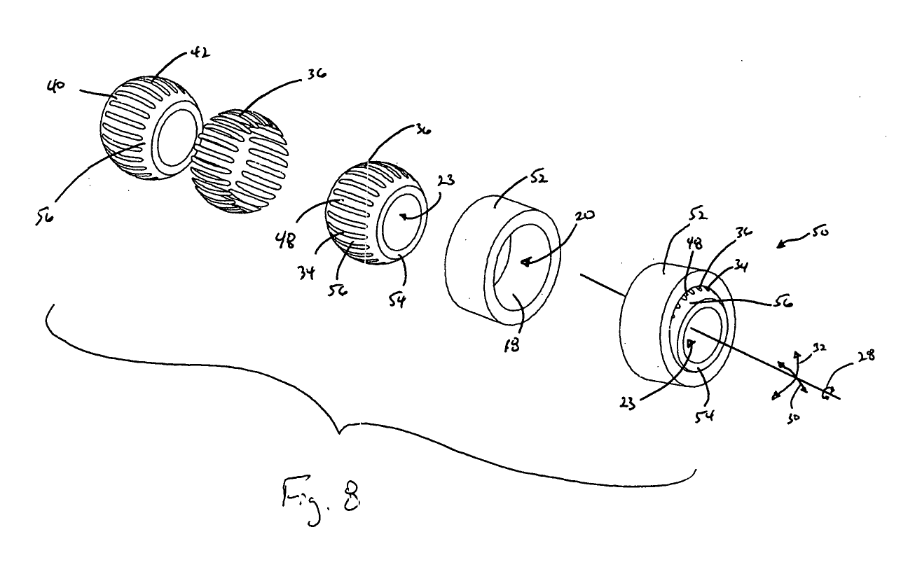

Referring now to FIG. 8, a self-lubricating spherical plain bearing 50 is shown exploded and fully assembled. The spherical bearing 50 includes an outer bearing member 52 and an inner bearing member 54 having lubricating material 36 that forms discrete lubricating regions 34 of an outer surface 56, as described above with reference to FIGS. 1-2A. Similar to the rod end bearing 10, the inner bearing member 54 of the spherical bearing 50 has multiple degrees of freedom in the directions of arrows 28, 30 and 32.

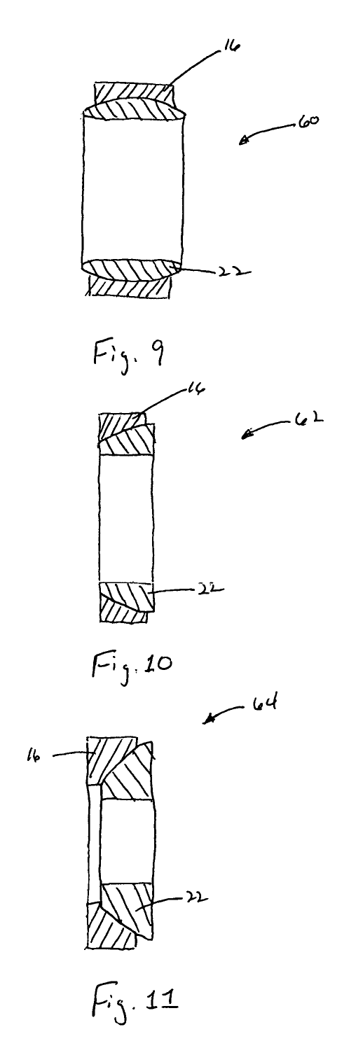

Referring to FIGS. 9-11, various bearing configurations are shown that include discrete lubricating regions (not shown), as described above. Referring to FIG. 9, a radial spherical plain bearing 60 is shown. FIG. 10 illustrates an angular contact spherical plain bearing 62 and FIG. 11 shows a spherical plain thrust bearing 64. A suitable bearing configuration, such as those described above with reference to FIGS. 9-11, can be selected based on operational factors, such as loading and alignment.

A number of detailed embodiments have been described. Nevertheless, it will be understood that various modifications may be made. For example, while bearings having inner members capable of multiple degrees of freedom relative to the outer members have been described, other configurations are contemplated such as bearings including an inner member capable of only one degree of freedom relative to the outer member (e.g., cylindrical plain bearings) where one or both the inner and outer bearing members includes discrete lubricating regions as described above. In some cases, during use of an assembled bearing, lubricating material 36 within regions 34 may migrate from regions 34 toward adjacent regions 48 of the associated bearing surface to provide a lubricious surface coating at the adjacent areas. Accordingly, other embodiments are within the scope of the following claims.

What is claimed is:

1. A self-lubricating bearing comprising:
an outer bearing member having a bore configured to receive an inner bearing member;
an inner bearing member disposed within the bore, the inner bearing member capable of rotating relative to the outer bearing member; and
at least one of the outer and inner bearing members comprising a lubricating material to define a discrete lubricating region of an associated bearing surface, the lubricating material filling a preform cavity extending inwardly from the surface of the respective bearing member.

2. The self-lubricating bearing of claim 1, wherein the inner bearing member and outer bearing member are configured such that the inner bearing member has more than one degree of freedom relative to the outer bearing member.

3. The self-lubricating bearing of claim 1, wherein the inner bearing member and outer bearing member are configured such that the inner bearing member has three degrees of freedom relative to the outer member.

4. The self-lubricating bearing of claim 1, wherein only the inner bearing member comprises the lubricating material.

5. The self-lubricating bearing of claim 1, wherein only the outer bearing member comprises the lubricating material.

6. The self-lubricating bearing of claim 1, wherein the preform cavity is formed by machining or casting.

7. The self-lubricating bearing of claim 1, wherein the lubricating material comprises graphite.

8. The self-lubricating bearing of claim 1 in the form of a rod end bearing.

9. The self-lubricating bearing of claim 1 in the form of a spherical plain bearing.

10. The self-lubricating bearing of claim 1, wherein the lubricating material has a coefficient of friction less than a coefficient of friction of a bearing material forming the associated bearing surface at a region adjacent the lubricating region.

11. A method of making a self-lubricating bearing comprising an outer bearing member having a bore configured to receive an inner bearing member and an inner bearing member disposed within the bore such that the inner bearing member is capable of rotating relative to the outer bearing member, the method comprising:
forming a cavity extending inwardly from a bearing surface of at least one of the inner and outer bearing members; and
filling the cavity with a lubricating material to define a discrete lubricating region of the respective bearing surface.

12. The method of claim 11 further comprising curing the lubricating material to permanently bond the lubricating material to the respective bearing member within the associated cavity.

13. The method of claim 11, wherein the step of forming includes machining or casting.

14. The method of claim 11, wherein the inner bearing member and the outer bearing member are configured such that the inner bearing member has more than one degree of freedom relative to the outer bearing member.

15. The method of claim 11, wherein the lubricating material comprises graphite.

16. The method of claim 11, wherein the self-lubricating bearing is in the form of a rod end bearing.

17. The method of claim 11, wherein the self-lubricating bearing is in the form of a spherical cartridge bearing.

18. The method of claim 11, wherein the step of forming the cavity includes forming the cavity extending from the surface of only the inner bearing member.

19. The method of claim 11, wherein the step of forming the cavity includes forming the cavity extending from the surface of only the outer bearing member.

20. The method of claim 11, wherein the lubricating material of the discrete lubricating region has a coefficient of friction less than a coefficient of friction of a bearing material forming the respective bearing surface at a region adjacent the lubricating region.
